(19) United States
(12) Patent Application Publication
(10) Pub. No.: US 2016/0142753 A1
(43) Pub. Date: May 19, 2016

(54) PREVIEW DETERMINATION

(71) Applicant: Empire Technology Development LLC, Wilmington, DE (US)

(72) Inventor: Shuichi KURABAYASHI, Fijisawa-shi (JP)

(21) Appl. No.: 14/895,637

(22) PCT Filed: Apr. 15, 2014
(86) PCT No.: PCT/US2014/034204

§ 371 Date: Dec. 3, 2015

(51) Int. Cl. H04N 21/2668; H04N 21/8549; H04N 21/472; H04N 21/24; H04N 21/25

(52) U.S. Cl. CPC H04N 21/2668; H04N 21/2407; H04N 21/252; H04N 21/47208; H04N 21/8549

(57) ABSTRACT

In some examples, a method performed under control of a server may include providing a plurality of preview video candidates of video content configured to be displayed on a plurality of end devices; and determining a first predetermined number of preview video candidates from among the plurality of preview video candidates, based at least in part on a first sale probability of the video content, which is associated with respective ones of the plurality of preview video candidates.

### BACKGROUND

Video-on-demand (VOD) services may provide video data, such as a movie or news via a network. In general, the VOD services may be implemented by compressing a video program using a digital data compression method such as MPEG-2, storing the compressed video program in a VOD server, and providing the stored video program to a subscriber via an Internet protocol (IP) network or a digital cable TV network when the subscriber requests the corresponding video program.

### SUMMARY

In an example, a method performed under control of a server may include providing a plurality of preview video candidates of video content configured to be displayed on a plurality of end devices; and determining a first predetermined number of preview video candidates from among the plurality of preview video candidates, based at least in part on a first sale probability of the video content, which is associated with respective ones of the plurality of preview video candidates.

In another example, a server may include a transmitting unit configured to transmit a plurality of preview video files of video content to a plurality of end devices; a purchase number counting unit configured to count a number of user accounts corresponding to the plurality of end devices, from which the video content was purchased, in association with respective ones of the plurality of preview video files; a sale probability calculating unit configured to calculate a first sale probability of the video content in association with respective ones of the plurality of preview video files, based at least in part on the counted number of the user accounts from which the video content was purchased and a total number of user accounts corresponding to the plurality of end devices; and a preview file selecting unit configured to select a first predetermined number of the preview video files from among the plurality of preview video files based at least in part on the calculated first sale probability of the video content, which is associated with respective ones of the plurality of preview video files.

In yet another example, a computer-readable storage medium having stored thereon computer-executable instructions that, in response to execution, may cause a server to perform operations including: providing a plurality of preview video candidates of video content configured to be displayed on a plurality of end devices; and determining a first predetermined number of preview video candidates from among the plurality of preview video candidates, based at least in part on a first sale probability of the video content, which is associated with respective ones of the plurality of preview video candidates.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of an environment including a server and at least one device group, arranged in accordance with at least some embodiments described herein;

FIG. 2 shows a schematic block diagram illustrating an example architecture for a server, arranged in accordance with at least some embodiments described herein;

FIG. 3 schematically shows an example flow diagram of a process of a server for transmitting a preview video content, arranged in accordance with at least some embodiments described herein;

FIG. 4 illustrates computer program products that may be utilized to provide a preview video content determining scheme, arranged in accordance with at least some embodiments described herein; and

FIG. 5 is a block diagram illustrating an example computing device that may be utilized to provide a preview video content determining scheme, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatuses, systems, devices, and computer program products related to a preview video content determining scheme. Technologies are generally described for a method for determining preview video content of video content from among multiple preview video candidates, based in part on a sale probability of the video content associated with respective ones of the multiple preview video candidates.

In some examples, a server may be configured to generate multiple preview video candidates of video content. For example, but not as a limitation, the video content may refer to video on demand (VOD) content or internet protocol television (IPTV) content. Each of the multiple preview video candidates may include different preview content or different play time. Further, the server may be configured to provide the multiple preview video candidates to multiple end devices. For example, but not as a limitation, it may be assumed that the server may generate ten preview video candidates and provide the ten preview video candidates to a hundred of end devices. The hundred of end devices may have a first highest content purchase frequency from among the multiple end devices. The server may be configured to distribute the ten preview video candidates to the hundred of end devices equally. Thus, each preview video candidates may be provided to each ten end devices.

In some embodiments, the video content may be purchased from some of the end devices when or after the multiple preview video candidates were provided to the end devices. The server may be configured to count a number of user accounts corresponding to the end devices from which the video content was purchased in association with respective ones of the multiple preview video candidates. Further, the server may be configured to calculate a sale probability of the video content in association with respective ones of the multiple preview video candidates. Then, the server may be further configured to select a predetermined number of the preview video candidates in order of the calculated sale probability of the video content. For the aforementioned example, the server may be configured to select a first, second, third and fourth preview video candidates from among the ten preview video candidates in order of the respective sale probabilities of the first, second, third and fourth preview video candidates.

The server may be configured to provide the selected predetermined number of the preview video candidates to another hundred of end devices. The other hundred of end devices may have a second highest content purchase frequency, which is lower than the first highest content purchase frequency. For the aforementioned example, the server may be configured to provide the selected first, second, third and fourth preview video candidates to another hundred of end devices. The server may be configured to provide each of the four preview video files to each twenty five end devices. Further, the server may be configured to count a number of user accounts corresponding to the end devices from which the video content was purchased in association with respective ones of the four preview video candidates. The server may be further configured to calculate a sale probability of the video content in association with respective ones of the four preview video candidates. Further, the server may be configured to select a predetermined number of the preview video candidates from among the four preview video candidates in order of the calculated sale probability of the video content. For the aforementioned example, if a sale probability of the video content associated with the second preview video candidate is greatest, the server may be configured to select the second preview video candidate, and to determine the second preview video candidate as a formal preview video candidate that corresponds to the video content. Then, the server may be configured to generate preview video content that includes the selected second preview video candidate, and to use the generated preview video content to invoke a user desire to purchase the video content. Thus, the server may be configured to perform recursively the above described process to narrow down the number of preview video candidates, and to determine final preview video candidate.

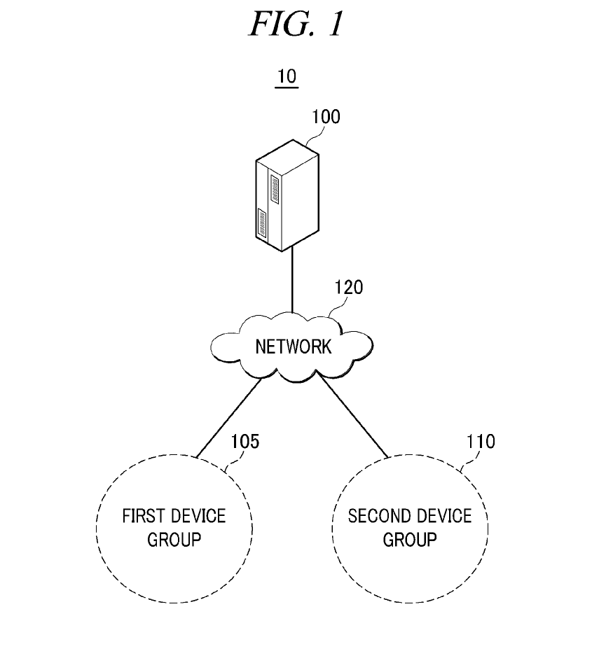

FIG. 1 schematically shows an illustrative example of an environment 10 including a server 100 and at least one device groups 105 and 110, arranged in accordance with at least some embodiments described herein. As illustrated in FIG. 1, server 100 and at least one device groups 105 and 110 may be connected to each other via a network 120. Each of device groups 105 and 110 may include multiple end devices.

As a non-limiting example, respective one of the multiple end devices may refer to a notebook computer; a personal computer; a smart phone; a tablet computer; a phablet device; and/or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

Network 120 may refer to a component or module that may be configured to communicatively couple at least two or more of and server 100 and device groups 105 and 110. Non-limiting examples of network 120 may include a wired network such as a LAN (Local Area Network), a WAN (Wide Area Network), a VAN (Value Added Network) or the like, or various other wireless networks such as a mobile radio communication network including at least one of a 3rd generation (3G) mobile telecommunications network, a 4th or 5th generation mobile telecommunications network, various other mobile telecommunications networks, a satellite network, WiBro (Wireless Broadband Internet), Mobile WiMAX, HSDPA (High Speed Downlink Packet Access), or the like. Alternatively, network 120 may include at least one of a near field communication (NFC), Bluetooth, or peer to peer (P2P) communication protocol.

Server 100 may refer to one or more apparatuses or servers that are hosted on or by an organization or entity that may be configured to provide video content. For example, but not as a limitation, the video content may refer to video-on-demand (VOD) content or IPTV content. In some embodiments, server 100 may be configured to determine multiple preview duration candidates of the video content. For example, but not as a limitation, the preview duration candidate may refer to a playing time interval or period among a total video stream of the video content. Each of the multiple preview duration candidates may have a different playing time interval or period. For example, but not as a limitation, each of the multiple preview duration candidates may be a playing time interval or period from a starting time point of the total video stream to a different ending time point in the total video stream. In some embodiments, server 100 may be configured to determine a number of the preview duration candidates based on a total number of end devices to receive multiple preview video candidates. For example, but not as a limitation, the number of the preview duration candidates may be less than one percent of the total number of the end devices.

Further, server 100 may be configured to generate multiple preview video candidates of the video content, based on the multiple preview duration candidates. Each of the multiple preview video candidates may have different preview content, since the corresponding preview duration candidate has a different playing time interval or period.

Further, server 100 may be configured to provide the multiple preview video candidates to multiple end devices. In some embodiments, server 100 may be configured to transmit, to multiple end devices, multiple preview video files that include the multiple preview video candidates of the video content. Further, each of the multiple end devices may download the preview video files. In some other embodiments, server 110 may be configured to stream the multiple preview video candidates to the multiple end devices. By way of example, but not as a limitation, server 100 may be configured to group the multiple end devices into first device group 105 and second device group 110. First device group 105 may include a first predetermined number of end devices. Further, second device group 110 may include a second predetermined number of end devices. In some embodiments, first device group 105 may include multiple end devices of which user accounts may have a first highest content purchase frequency from among multiple user accounts corresponding to the multiple end devices. For example, the first highest content purchase frequency may refer to a purchase frequency or a purchase frequency range that belongs to a ten or fifteen percent from the top of a content purchase frequency ranking. Further, second device group 110 may include multiple end devices of which user accounts may have a second highest content purchase frequency from among the multiple user accounts corresponding to the multiple end devices. For example, the second highest content purchase frequency may refer to a purchase frequency or a purchase frequency range that belongs to a thirty or forty percent from the top of the content purchase frequency ranking. For example, but not as a limitation, each user account corresponding to each end device may include an identifier assigned to the end device or a user of the end device.

In some embodiments, server 100 may be configured to provide the multiple preview video candidates of the video content to first device group 105. A preview video viewing history of each end device may be stored in a memory communicatively coupled to server 100. For example, but not as a limitation, it may be assumed that server 100 may generate ten preview video candidates of the video content and first device group 105 may include a hundred of end devices. Server 100 may be configured to determine a number of end devices to receive each of the multiple preview video candidates from among the first predetermined number of end devices included in first device group 105. For example, but not as a limitation, server 100 may be configured to transmit each of the ten preview video candidates to each ten end devices. Thus, one preview video candidates may be transmitted to ten end devices.

Further, server 100 may be configured to determine a predetermined number of the preview video candidates from among the multiple preview video candidates, based on a sale probability of the video content in associated with respective ones of the multiple preview video candidates. In some embodiments, server 100 may be configured to count a number of user accounts corresponding to the end devices, from which the video content was purchased, in association with respective ones of the multiple preview video candidates. A content purchase history of each user account corresponding to each end device may be stored in a memory communicatively coupled to server 100 in association with respective ones of the multiple preview video candidates. For the above example, server 100 may be configured to count a first number of user accounts corresponding to the end devices, from which the video content was purchased, from among the hundred of end devices included in first device group 105. Further, server 100 may be configured to count the first number of the user accounts corresponding to the end devices in association with respective ones of the ten preview video candidates. In some embodiments, server 100 may be configured to count the first number of the user accounts corresponding to the end devices, from which the video content was purchased, from among the determined number (e.g., ten) of the end devices that received each of the ten preview video candidates, in association with respective ones of the ten preview video candidates.

Further, server 100 may be configured to calculate a sale probability of the video content in association with respective ones of the multiple preview video candidates, based on the counted number of the user accounts from which the video content was purchased and a total number of the multiple end devices to which the multiple preview video candidates were provided. For the above example, server 100 may be configured to calculate a first sale probability of the video content in association with respective ones of the ten preview video candidates by dividing the counted first number of user accounts corresponding to the end devices that received each of the ten preview video files and purchased the video content by ten (i.e., the number of user accounts corresponding to end devices to which each of the ten preview video files were provided).

Further, server 100 may be configured to select a predetermined number of the preview video candidates from among the multiple preview video candidates, based on the calculated sale probability associated with respective ones of the multiple preview video candidates. In some embodiments, server 100 may be configured to select the predetermined number of the preview video candidates in order of the calculated sale probability of the video content. For the above example, but not as a limitation, server 100 may be configured to select a first predetermined number of the preview video candidates (e.g., three preview video candidates) which have sale probabilities ranked at about thirty percent from the top of the sale probability from among the ten preview video candidates.

Further, server 100 may be configured to provide the selected predetermined number of the preview video candidates to second device group 110. For example, it may be assumed that second device group 110 may include one hundred eighty end devices. For the above example, server 100 may be configured to provide each of the three preview video candidates (i.e., first predetermined number of the preview video candidates) to sixty end devices. Thus, one preview video candidate may be provided to sixty end devices.

Further, server 100 may be configured to count a number of user accounts corresponding to end devices, from which the video content was purchased, in association with respective ones of the transmitted predetermined number of preview video candidates. For the above example, server 100 may be configured to count a second number of user accounts corresponding to the end devices, from which the video content was purchased, from among the one hundred eighty end devices included in second device group 110. Further, server 100 may be configured to count the second number of the user accounts in association with respective ones of the three preview video candidates.

Further, server 100 may be configured to calculate a second sale probability of the video content in association with respective ones of the three preview video candidates by dividing the counted second number of user accounts corresponding to the end devices that received each of the three preview video candidates and purchased the video content by sixty (i.e., the number of end devices to which each of the three preview video candidates were provided).

Further, server 100 may be configured to select a second predetermined number of the preview video candidates from among the first predetermined number of the preview video candidates, based on the calculated second sale probability. For example, but not as a limitation, server 100 may be configured to select one preview video candidate, which has a top ranked sale probability, from among the three preview video candidates.

Further, server 100 may be configured to determine the selected second predetermined number of preview video candidates (e.g., one preview video candidate) as a formal preview video candidate corresponding to the video content. Further, server 100 may be configured to generate preview video content that includes the selected second predetermined number of preview video candidates. Further, server 100 may be configured to provide the generated preview video content to multiple end devices to invoke a user desire to purchase the video content.

Server 100 may be configured to perform recursively the above described process (e.g., providing preview video candidates, counting a number of user accounts corresponding to end devices from which video content was purchased and calculating a sale probability) to narrow down the number of preview video candidates. Thus, server 100 may be configured to determine a final preview video candidate.

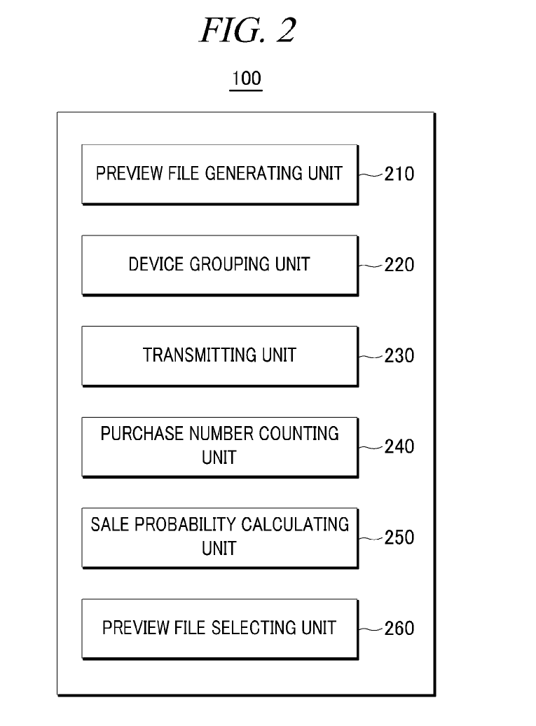

FIG. 2 shows a schematic block diagram illustrating an example architecture for a server 100, arranged in accordance with at least some embodiments described herein. As depicted in FIG. 2, server 100 may include a preview file generating unit 210, a device grouping unit 220, a transmitting unit 230, a purchase number counting unit 240, a sale probability calculating unit 250, and a preview file selecting unit 260. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In that regard, one or more of preview file generating unit 210, device grouping unit 220, transmitting unit 230, purchase number counting unit 240, sale probability calculating unit 250, and preview file selecting unit 260 may be included in an instance of an application hosted on server 100.

Preview file generating unit 210 may be configured to determine multiple preview duration candidates of video content. Further, preview file generating unit 210 may be configured to generate multiple preview video files of the video content based on the multiple preview duration candidates. Each of the multiple preview video files may have different preview content, since the corresponding preview duration candidate has a different playing time interval or period among a total video stream of the video content. Further, in some embodiments, preview file generating unit 210 may be configured to determine a number of the multiple preview video files based on a total number of end devices to which the multiple preview video files to be transmitted. For example, but not as a limitation, the number of the multiple preview video files may be less than one percent of the total number of the multiple end devices.

Device grouping unit 220 may be configured to group the multiple end devices into multiple device groups, based on a content purchase frequency of each user account corresponding to each of the end devices. For example, but not as a limitation, a content purchase history associated with each user account may be stored in a memory communicatively coupled to server 100. Each device group may include a predetermined number of end devices. For example, but not as a limitation, device grouping unit 220 may be configured to divide the end devices into a first device group and a second device group. In some embodiments, the first device group may include a first predetermined number of end devices that may have a first highest content purchase frequency from among the multiple end devices. Further, device grouping unit 220 may be configured to determine a number of end devices to receive each preview video file from among the first predetermined number of end devices included in the first device group. For example, but not as a limitation, device grouping unit 220 may be configured to determine the number of end devices to receive each preview video file by dividing the first predetermined number of the end devices included in the first device group by a total number of preview video files to be transmitted to the first device group.

Further, the second device group may include a second predetermined number of end devices that may have a second highest content purchase frequency, which is lower than the first highest content purchase frequency, from among the multiple end devices. Further, device grouping unit 220 may be configured to determine a number of end devices to receive each preview video file from among the second predetermined number of end devices included in the second device group. For example, but not as a limitation, device grouping unit 220 may be configured to determine the number of end devices to receive each preview video file by dividing the second predetermined number of the end devices included in the second device group by a total number of preview video files to be transmitted to the second device group.

Transmitting unit 230 may be configured to transmit, to the multiple end devices, the multiple preview video files of the video content to be displayed on the multiple end devices. In some embodiments, transmitting unit 230 may be configured to transmit the multiple preview video files of the video content to the first device group. Transmitting unit 230 may be configured to transmit each of the multiple preview video files to the determined number of end devices included in the first device group. A preview video viewing history of each end device may be stored in a memory communicatively coupled to server 100.

Further, transmitting unit 230 may be configured to transmit, to the second device group, a first predetermined number of preview video files from among the multiple preview video files.

Purchase number counting unit 240 may be configured to count a number of user accounts corresponding to the end devices, from which the video content was purchased, in association with respective ones of the multiple preview video files. A content purchase history of each user account corresponding to each end device may be stored in a memory communicatively coupled to server 100 in association with respective ones of the multiple preview video files. In some embodiments, purchase number counting unit 240 may be configured to count a first number of user accounts corresponding to the end devices, from which the video content was purchased, from among the first predetermined number of the end devices included in the first device group. Further, purchase number counting unit 240 may be configured to count the first number of the user accounts in association with respective ones of the preview video files. In some embodiments, purchase number counting unit 240 may be configured to count the first number of the user accounts corresponding to the end devices, from which the video content was purchased, from among the determined number of the end devices that received each of the preview video files, in association with respective ones of the preview video files.

Further, purchase number counting unit 240 may be configured to count a second number of user accounts corresponding to the end devices, from which the video content was purchased, from among the second predetermined number of the end devices included in the second device group. Further, purchase number counting unit 240 may be configured to count the second number of the user accounts in association with respective ones of the first predetermined number of the preview video files transmitted to the second device group.

Sale probability calculating unit 250 may be configured to calculate a sale probability of the video content in association with respective ones of the multiple preview video files, based on the counted number of the user accounts from which the video content was purchased and a total number of the multiple end devices to which the multiple preview video files were transmitted.

In some embodiments, sale probability calculating unit 250 may be configured to calculate a first sale probability of the video content in association with respective ones of the preview video files transmitted to the first device group by dividing the counted first number of the user accounts corresponding to the end devices that received each of the preview video files and purchased the video content by the determined number of the end devices to which each of the preview video files was transmitted.

Further, sale probability calculating unit 250 may be configured to calculate a second sale probability of the video content in association with respective ones of the first predetermined number of the preview video files transmitted to the second device group by dividing the counted second number of the user accounts corresponding to the end devices that received each of the first predetermined number of preview video files and purchased the video content by the determined number of the end devices to which each of the first predetermined number of the preview video files was transmitted.

Preview file selecting unit 260 may be configured to select the first predetermined number of the preview video files from among the multiple preview video files, based on the calculated first sale probability associated with respective ones of the multiple preview video files. In some embodiments, preview file selecting unit 260 may be configured to select the first predetermined number of the preview video files in order of the calculated first sale probability of the video content. For example, but not as a limitation, preview file selecting unit 260 may be configured to select the first predetermined number of the preview video files from among the total preview video files, which have sale probabilities ranked at about thirty percent from the top of the sale probability.

Further, preview file selecting unit 260 may be configured to select a second predetermined number of the preview video files from among the first predetermined number of the preview video files transmitted to the second device group. Preview file selecting unit 260 may be configured to select the second predetermined number of the preview video files, based on the calculated second sale probability associated with respective ones of the first predetermined number of the preview video files.

Further, preview file selecting unit 260 may be configured to determine the selected second predetermined number (e.g., one preview video file) of the preview video files as a final preview video file corresponding to the video content. Then, server 100 may be configured to generate preview video content that includes the final preview video file, and to transmit the generated preview video content to multiple end devices to invoke a user desire to purchase the video content.

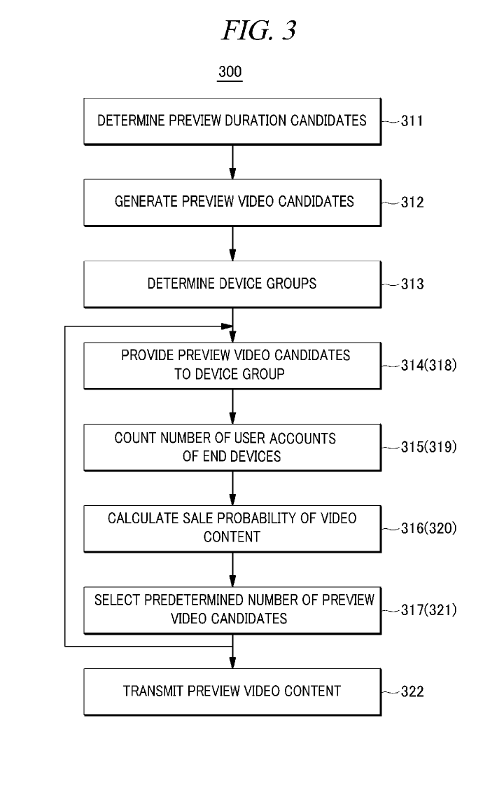

FIG. 3 schematically shows an example flow diagram of a process 300 of a server 100 for transmitting a preview video content, arranged in accordance with at least some embodiments described herein. The process in FIG. 3 may be implemented in environment 10 including server 100 and device groups 105 and 110, as illustrated in FIG. 1. An example process may include one or more operations, actions, or functions as illustrated by one or more blocks 311, 312, 313, 314, 315, 316, 317, 318, 319, 320, 321 and/or 322. Although illustrated as discrete blocks, various blocks may be divided into additional blocks, combined into fewer blocks, or eliminated, depending on the desired implementation. Processing may begin at block 311.

At block 311 (Determine Preview Duration Candidates), server 100 may determine multiple preview duration candidates of video content. In some embodiments, each of the multiple preview duration candidates may have a different playing time interval or period in a total video stream of the video content. Server 100 may determine a number of the preview duration candidates, based on a total number of end devices to which preview video files to be transmitted. Processing may proceed from block 311 to block 312.

At block 312 (Generate Preview Video Candidates), server 100 may generate multiple preview video candidates of the video content to be displayed on multiple end devices, based on the multiple preview duration candidates determined at block 311. Each of the multiple preview video candidates may have different preview content, since the corresponding preview duration candidate has a different playing time interval or period. Processing may proceed from block 312 to block 313.

At block 313 (Determine Device Groups), server 100 may determine multiple device groups, based on a content purchase frequency of each user account corresponding to each of the end devices. For example, but not as a limitation, at block 313, server 100 may divide the multiple end devices into a first device group and a second device group. In some embodiments, the first device group may include a first predetermined number of end devices that may have a first highest content purchase frequency from among the multiple end devices. Further, the second device group may include a second predetermined number of end devices that may have a second highest content purchase frequency, which is lower than the first highest content purchase frequency, from among the multiple end devices. Processing may proceed from block 313 to block 314.

At block 314 (Provide Preview Video Candidates to Device Group), server 100 may provide the multiple preview video candidates generated at block 312 to the first device group. A preview video viewing history of each end device may be stored in a memory communicatively coupled to server 100. In some embodiments, at block 314, server 100 may provide each of the multiple preview video candidates to a determined number of end devices included in the first device group. For example, the number of the end devices to receive each preview video file may be determined by dividing the first predetermined number of the end devices included in the first device group by a total number of the preview video candidates to be provided to the first device group. Processing may proceed from block 314 to block 315.

At block 315 (Count Number of User Accounts of End Devices), server 100 may count a first number of user accounts of the end devices, from which the video content was purchased, from among the first predetermined number of the end devices included in the first device group. Further, server 100 may count the first number of the user accounts in association with respective ones of the preview video candidates. In some embodiments, a content purchase history of each user account corresponding to each end device may be stored in a memory communicatively coupled to server 100 in association with respective ones of the preview video candidates. Further, server 100 may count the first number of the user accounts from the memory in association with respective ones of the preview video candidates. Processing may proceed from block 315 to block 316.

At block 316 (Calculate Sale Probability of Video Content), server 100 may calculate a first sale probability of the video content in association with respective ones of the multiple preview video candidates, based on the counted first number of the user accounts and a total number of the multiple end devices to which the multiple preview video candidates were provided. For example, but not as a limitation, server 100 may calculate the first sale probability of the video content in association with respective ones of the preview video candidates by dividing the counted first number of the user accounts corresponding to the end devices that received each of the preview video files and purchased the video content by the number of the end devices that received each of the preview video candidates. Processing may proceed from block 316 to block 317.

At block 317 (Select Predetermined Number of Preview Video Candidates), server 100 may select a first predetermined number of preview video candidates from among the multiple preview video candidates provided to the first device group, based on the calculated first sale probability associated with respective ones of the multiple preview video candidates. In some embodiments, at block 317, server 100 may select the first predetermined number of the preview video candidates in order of the calculated first sale probability of the video content. For example, but not as a limitation, server 100 may select the first predetermined number of the preview video candidates, from among the total preview video candidates, which have sale probabilities ranked at about thirty percent from the top of the sale probability. Processing may proceed from block 317 to block 318.

At block 318 (Provide Preview Video Candidates to Device Group), server 100 may provide the first predetermined number of preview video candidates selected at block 317 to the second device group. In some embodiments, at block 318, server 100 may distribute the first predetermined number of the preview video candidates to the second predetermined number of the end devices included in the second device group equally. For example, but not as a limitation, the number of end devices to receive each preview video candidates may be determined by dividing the second predetermined number of the end devices included in the second device group by the total first predetermined number of the preview video candidates to be provided to the second device group. Processing may proceed from block 318 to block 319.

At block 319 (Count Number of User Accounts of End Devices), server 100 may count a second number of user accounts of the end devices, from which the video content was purchased, from among the second predetermined number of the end devices included in the second device group. Further, server 100 may count the second number of the user accounts in association with respective ones of the first predetermined number of the preview video candidates. In some embodiments, a content purchase history of each user account corresponding to each end device may be stored in a memory communicatively coupled to server 100 in association with respective ones of the first predetermined number of the preview video candidates. Further, server 100 may count the second number of the user accounts from the memory in association with respective ones of the first predetermined number of the preview video candidates. Processing may proceed from block 319 to block 320.

At block 320 (Calculate Sale Probability of Video Content), server 100 may calculate a second sale probability of the video content in association with respective ones of the first predetermined number of the preview video candidates, based on the counted second number of the user accounts and the second predetermined number of the end devices to which the first predetermined number of the preview video candidates were provided. For example, but not as a limitation, server 100 may calculate the second sale probability of the video content in association with respective ones of the first predetermined number of the preview video candidates by dividing the counted second number of the user accounts corresponding to the end devices that received each of the first predetermined number of the preview video candidates and purchased the video content by a number of the end devices that received each of the first predetermined number of the preview video candidates. Processing may proceed from block 320 to block 321.

At block 321 (Select Predetermined Number of Preview Video Candidates), server 100 may select a second predetermined number of preview video candidates from among the first predetermined number of the preview video candidates provided to the second device group, based on the calculated second sale probability associated with respective ones of the first predetermined number of the preview video candidates. In some embodiments, at block 321, server 100 may select the second predetermined number of the preview video candidates in order of the calculated second sale probability of the video content. For example, but not as a limitation, server 100 may select the second predetermined number of the preview video candidates, from among the first predetermined number of the preview video candidates, which have sale probabilities ranked at about thirty percent from the top of the sale probability. For another example, server 100 may select one preview video candidate that has a greatest sale probability from among the first predetermined number of the preview video candidates. Processing may proceed from block 321 to block 322.

At block 322 (Provide Preview Video Content), server 100 may determine and/or generate preview video content that includes the second predetermined number (e.g., one preview video candidate) of preview video candidates selected at block 321. Further, server 100 may provide the determined and/or generated preview video content to multiple end devices to invoke a user desire to purchase the video content.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

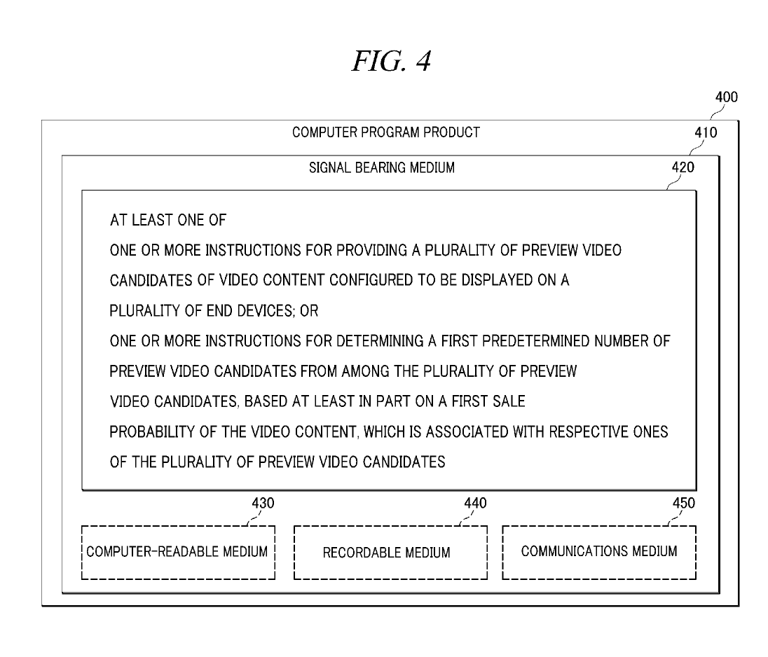

FIG. 4 illustrates computer program products that may be utilized to provide a preview video content determining scheme, arranged in accordance with at least some embodiments described herein. Program product 400 may include a signal bearing medium 410. Signal bearing medium 410 may include one or more instructions 420 that, when executed by, for example, a processor, may provide the functionality described above with respect to FIGS. 1-3. By way of example, instructions 420 may include: one or more instructions for providing a plurality of preview video candidates of video content configured to be displayed on a plurality of end devices; or one or more instructions for determining a first predetermined number of preview video candidates from among the plurality of preview video candidates, based at least in part on a first sale probability of the video content, which is associated with respective ones of the plurality of preview video candidates. Thus, for example, referring to FIG. 3, server 100 may undertake one or more of the blocks shown in FIG. 3 in response to instructions 420.

In some implementations, signal bearing medium 410 may encompass a computer-readable medium 430, such as, but not limited to, a hard disk drive, a CD, a DVD, a digital tape, memory, etc. In some implementations, signal bearing medium 410 may encompass a recordable medium 440, such as, but not limited to, memory, read/write (R/W) CDs, R/W DVDs, etc. In some implementations, signal bearing medium 410 may encompass a communications medium 450, such as, but not limited to, a digital and/or an analog communication medium (e.g., a fiber optic cable, a waveguide, a wired communications link, a wireless communication link, etc.). Thus, for example, program product 400 may be conveyed to one or more modules of server 100 by an RF signal bearing medium 410, where signal bearing medium 410 is conveyed by a wireless communications medium 450 (e.g., a wireless communications medium conforming with the IEEE 802.11 standard).

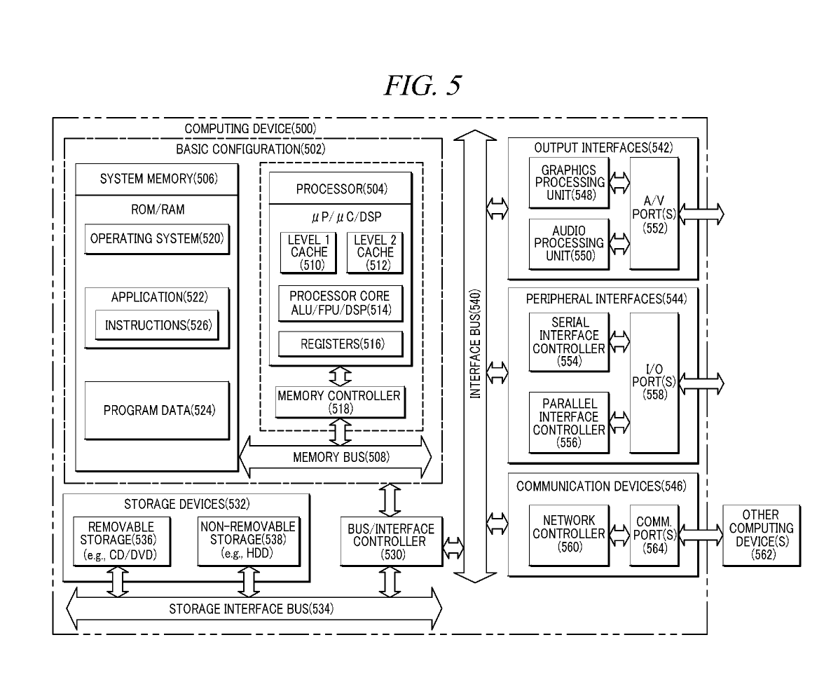

FIG. 5 is a block diagram illustrating an example computing device that may be utilized to provide a preview video content determining scheme, arranged in accordance with at least some embodiments described herein. In these examples, elements of computing device 500 may be arranged or configured for a device. In a very basic configuration 502, computing device 500 typically includes one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. Processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, system memory 506 may be of any type including but not limited to volatile memory (such as RAM), nonvolatile memory (such as ROM, flash memory, etc.) or any combination thereof. System memory 506 may include an operating system 520, an application 522, and program data 524. Application 522 may include instructions 526 that may be arranged to perform the functions as described herein including the actions described with respect to server 100 architecture as shown in FIG. 2 or including the actions described with respect to the flow charts shown in FIG. 3. In some examples, application 522 may be arranged to operate with program data 524 on an operating system 520 such that the schemes for determining preview video.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 540 for facilitating communication from various interface devices (e.g., output devices 542, peripheral interfaces 544, and communication devices 546) to basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a server, comprising:
providing a plurality of preview video candidates of video content configured to be displayed on a plurality of end devices; and
determining a first predetermined number of preview video candidates from among the plurality of preview video candidates, based at least in part on a first sale probability of the video content, which is associated with respective ones of the plurality of preview video candidates.

2. The method of claim 1, wherein the determining of the first predetermined number of preview video candidates includes:
counting a number of user accounts corresponding to the plurality of end devices from which the video content was purchased in association with respective ones of the plurality of preview video candidates;
calculating the first sale probability of the video content in association with respective ones of the plurality of preview video candidates, based at least in part on the counted number of the user accounts from which the video content was purchased and a total number of user accounts corresponding to the plurality of end devices; and
selecting the first predetermined number of the preview video candidates from among the plurality of preview video candidates based at least in part on the calculated first sale probability of the video content.

3. The method of claim 2, further comprising:
grouping the plurality of end devices into a plurality of device groups based at least in part on a content purchase frequency of each of the user accounts corresponding to the plurality of end devices,
wherein each of the plurality of device groups includes a predetermined number of the end devices,
wherein the providing includes:
providing the plurality of preview video candidates to a first device group that has a first-highest content purchase frequency from among the plurality of device groups.

4. The method of claim 3, wherein the counting includes:
counting a first number of the user accounts corresponding to the end devices included in the first device group, from which the video content was purchased, in association with respective ones of the plurality of preview video candidates,
wherein the calculating includes:
calculating the first sale probability of the video content in association with respective ones of the plurality of preview video candidates, based at least in part on the counted first number of the user accounts and the predetermined number of the end devices included in the first device group.

5. The method of claim 4, after the selecting of the first predetermined number of the preview video candidates, further comprising:
providing the first predetermined number of the preview video candidates to a second device group that has a second-highest content purchase frequency from among the plurality of device groups;
counting a second number of the user accounts corresponding to the end devices included in the second device group, from which the video content was purchased, in association with respective ones of the first predetermined number of the preview video candidates;
calculating a second sale probability of the video content in association with respective ones of the first predetermined number of the preview video candidates, based at least in part on the counted second number of the user accounts from which the video content was purchased and the predetermined number of the end devices included in the second device group; and
selecting a second predetermined number of the preview video candidates from among the first predetermined number of the preview video candidates, based at least in part on the calculated second sale probability of the video content.

6. The method of claim 3, wherein each of the plurality of preview video candidates has different preview content,
the method further comprises:
determining a number of the end devices to receive each of the plurality of preview video candidates from among the predetermined number of the end devices included in the first device group, and
wherein the providing includes:
providing each one of the plurality of preview video candidates to the determined number of the end devices.

7. The method of claim 6, wherein the counting includes:
counting a number of the user accounts corresponding to the end devices from among the determined number of the end devices, from which the video content was purchased, in association with respective ones of the plurality of preview video candidates,
wherein the calculating includes:
calculating the first sale probability of the video content in association with respective ones of the plurality of preview video candidates, based at least in part on the counted number of the user accounts from which the video content was purchased and the determined number of the end devices that received each of the plurality of preview video candidates.

8. The method of claim 2, wherein the selecting is performed in order of the calculated first sale probability of the video content, which is associated with respective ones of the plurality of preview video candidates.

9. The method of claim 2, wherein a number of the plurality of preview video candidates of the video content is determined based at least in part on the number of the plurality of end devices.

10. The method of claim 2, further comprising:
determining a plurality of preview duration candidates; and
generating each of the plurality of preview video candidates of the video content based at least in part on a corresponding preview duration candidate from among the determined plurality of the preview duration candidates.

11. A server, comprising:
a transmitting unit configured to transmit a plurality of preview video files of video content to a plurality of end devices;
a purchase number counting unit configured to count a number of user accounts corresponding to the plurality of end devices, from which the video content was purchased, in association with respective ones of the plurality of preview video files;
a sale probability calculating unit configured to calculate a first sale probability of the video content in association with respective ones of the plurality of preview video files, based at least in part on the counted number of the user accounts from which the video content was purchased and a total number of user accounts corresponding to the plurality of end devices; and
a preview file selecting unit configured to select a first predetermined number of the preview video files from among the plurality of preview video files based at least in part on the calculated first sale probability of the video content, which is associated with respective ones of the plurality of preview video files.

12. The server of claim 11, further comprising:
a device grouping unit configured to group the plurality of end devices into a plurality of device groups based at least in part on a content purchase frequency of each of the user accounts corresponding to the plurality of end devices,
wherein each of the plurality of device groups includes a predetermined number of the end devices,
wherein the transmitting unit is further configured to transmit the plurality of preview video files to a first device group that has a first-highest content purchase frequency from among the plurality of device groups.

13. The server of claim 12, wherein the purchase number counting unit is further configured to count a first number of the user accounts corresponding to the end devices included in the first device group, from which the video content was purchased, in association with respective ones of the plurality of preview video files, and
wherein the sale probability calculating unit is further configured to calculate the first sale probability of the video content in association with respective ones of the plurality of preview video files, based at least in part on the counted first number of the user accounts from which the video content was purchased and the predetermined number of the end devices included in the first device group.

14. The server of claim 13, wherein the transmitting unit is further configured to transmit the first predetermined number of the preview video files to a second device group that has a second-highest content purchase frequency from among the plurality of device groups,
wherein the purchase number counting unit is further configured to count a second number of the user accounts corresponding to the end devices included in the second device group, from which the video content was purchased, in association with respective ones of the first predetermined number of the preview video files,
wherein the sale probability calculating unit is further configured to calculate a second sale probability of the video content in association with respective ones of the first predetermined number of the preview video files, based at least in part on the counted second number of the user accounts from which the video content was purchased and the predetermined number of the end devices included in the second device group,
wherein the preview file selecting unit is further configured to select a second predetermined number of the preview video files from among the first predetermined number of the preview video files, based at least in part on the calculated second sale probability of the video content, which is associated with respective ones of the first predetermined number of the preview video files.

15. The server of claim 12, wherein each of the plurality of preview video files has different preview content,
wherein the device grouping unit is further configured to determine a number of the end devices to receive each of the plurality of preview video files from among the predetermined number of the end devices included in the first device group, and
wherein the transmitting unit is further configured to transmit each one of the plurality of preview video files to the determined number of the end devices.

16. The server of claim 15, wherein the purchase number counting unit is further configured to count a number of the user accounts corresponding to the end devices from among the determined number of the end device, from which the video content was purchased, in association with respective ones of the plurality of preview video files,
wherein the sale probability calculating unit is further configured to calculate the first sale probability of the video content in association with respective ones of the plurality of preview video files, based at least in part on the counted number of the user accounts from which the video content was purchased and the determined number of the end devices that received each of the plurality of preview video files.

17. The server of claim 11, wherein the preview file selecting unit is further configured to select the first predetermined number of the preview video files from among the plurality of preview video files in order of the calculated first sale probability of the video content, which is associated with respective ones of the plurality of preview video files.

18. The server of claim 11, further comprising:
a preview file generating unit configured to generate the plurality of preview video files of the video content,
wherein the preview file generating unit is further configured to determine a number of the plurality of preview video files to be generated based at least in part on the number of the plurality of end devices.

19. The server of claim 11, wherein the preview file generating unit is further configured to:
determine a plurality of preview duration candidates; and
generate each of the plurality of preview video files based at least in part on a corresponding preview duration candidate from among the determined plurality of the preview duration candidates.

20. A non-transitory computer-readable storage medium having stored thereon computer-executable instructions that, in response to execution, cause a server to perform operations, comprising:
providing a plurality of preview video candidates of video content configured to be displayed on a plurality of end devices; and
determining a first predetermined number of preview video candidates from among the plurality of preview video candidates, based at least in part on a first sale probability of the video content, which is associated with respective ones of the plurality of preview video candidates.

21. The computer-readable storage medium of claim 20, wherein the determining of the first predetermined number of preview video candidates includes:
counting a number of user accounts corresponding to the plurality of end devices from which the video content was purchased in association with respective ones of the plurality of preview video candidates;
calculating the first sale probability of the video content in association with respective ones of the plurality of preview video candidates, based at least in part on the counted number of the user accounts from which the video content was purchased and a total number of user accounts corresponding to the plurality of end devices; and
selecting the first predetermined number of the preview video candidates from among the plurality of preview video candidates based at least in part on the calculated first sale probability of the video content.
